(19) United States
(12) Patent Application Publication
(10) Pub. No.: US 2002/0067014 A1
(43) Pub. Date: Jun. 6, 2002

(54) Scooter having easily assembled brake device

(76) Inventors: Bernhard Heringer, Taichung (TW); Ming Chih Cheng, Taichung (TW)

Correspondence Address: Bernhard Heringer, P.O. Box 63-99, Taichung, 406, TW

(21) Appl. No.: 09/729,446

(22) Filed: Dec. 1, 2000

(51) Int. Cl. B62B 9/16

(52) U.S. Cl. 280/87.041; 280/847

(57) ABSTRACT

A scooter includes a wheel rotatably secured to a board, a spring engaged in one end of the mudguard, and a shaft engaged through the mudguard and the spring for easily and quickly securing the mudguard and the spring to the board. The spring may bias the mudguard away from the wheel. The mudguard includes a bulge extended from the inner peripheral surface for engaging with the wheel and for decreasing the contacting area of the mudguard with the wheel. The spring has two coils engaged on the shaft, and a connected middle portion for increasing the resilience of the spring.

### BACKGROUND OF THE INVENTION

1. Field of the Invention

The present invention relates to a scooter, and more particularly to a scooter having an easily assembled brake device.

2. Description of the Prior Art

A shown in FIG. 1, a typical scooter includes a board 10 for supporting a user, a wheel 32 rotatably secured to the rear portion of the board 10 with an axle 33, and a mudguard 20 having one end pivotally secured to the board 10 with a pivot pin 31 and having an inner peripheral surface 21 for engaging with the rear wheel 32 and for braking purposes. A spring 13 has one end secured to the board 10 with a fastener 12 that is threaded with a screw hole 11 of the board 10, and has the other end 14 engaged with the mudguard 20 for biasing the mudguard 20 away from the rear wheel 32. The mudguard 20 may be depressed downward toward and to engage with the rear wheel 32 by the feet of the user, in order to brake the rear wheel 32 of the scooter. The spring 13 may be easily disengaged from the board 10 when the screw 12 is unthreaded relative to the board 10 inadvertently or after use. In addition, the dirt or mud or the like may be attached onto or accumulated in the inner peripheral surface of the mudguard 20 such that the mudguard 20 may not be used to effectively engage with or brake the rear wheel 32.

The present invention has arisen to mitigate and/or obviate the afore-described disadvantages of the conventional scooters.

### SUMMARY OF THE INVENTION

The primary objective of the present invention is to provide a scooter including an easily assembled brake device and spring member.

In accordance with one aspect of the invention, there is provided a scooter comprising a board, a wheel rotatably secured to the board, a mudguard including a first end, a spring engaged in the first end of the mudguard, and a shaft engaged through the first end of the mudguard and the spring for securing the mudguard and the spring to the board. The spring is engaged with the board and the mudguard for biasing the mudguard away from the wheel. The shaft is simultaneously engaged through the first end of the mudguard and the spring such that the mudguard and the spring may be easily and quickly secured to the board with the shaft.

The mudguard includes an inner peripheral surface facing toward the wheel, and includes a bulge extended from the inner peripheral surface thereof for engaging with the wheel and for decreasing the contacting area of the mudguard with the wheel.

The first end of the mudguard includes a notch formed and defined between a pair of legs for receiving the spring such that the spring may also be engaged on the shaft.

The spring includes two coils engaged on the shaft, and includes two outer ends engaged with the board, and includes a middle portion connected between the coils and engaged with the mudguard, such that the spring includes an excellent resilient or biasing member.

The shaft includes a plurality of teeth formed thereon for engaging with the board and for solidly securing to the board. The shaft may be hammered and disengaged from the board for replacing or changing the spring and/or the mudguard.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial plane view showing a typical brake device for a typical scooter;

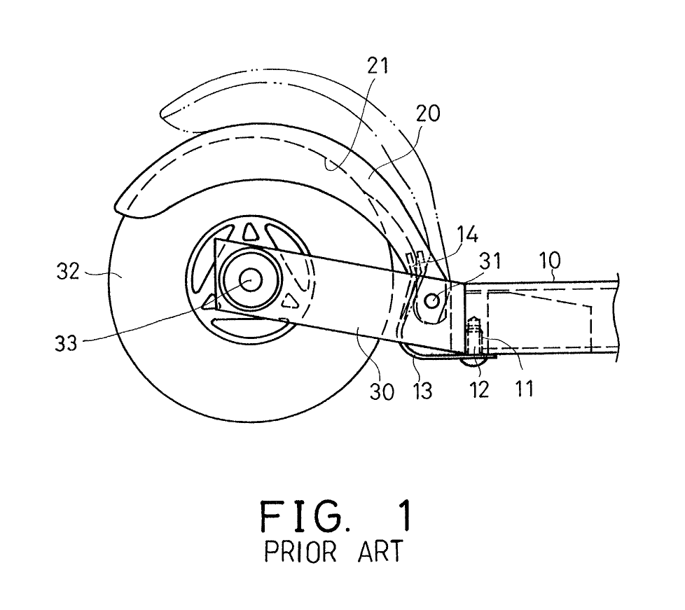

FIG. 2 is a partial exploded view of a brake device for a scooter in accordance with the present invention;

FIG. 3 is a partial cross sectional view of the scooter;

FIG. 4 is a partial cross sectional view similar to FIG. 3, illustrating the operation of the brake device for the scooter.

### DETAILED DESCRIPTION OF THE PREFERRED EMBODIMENT

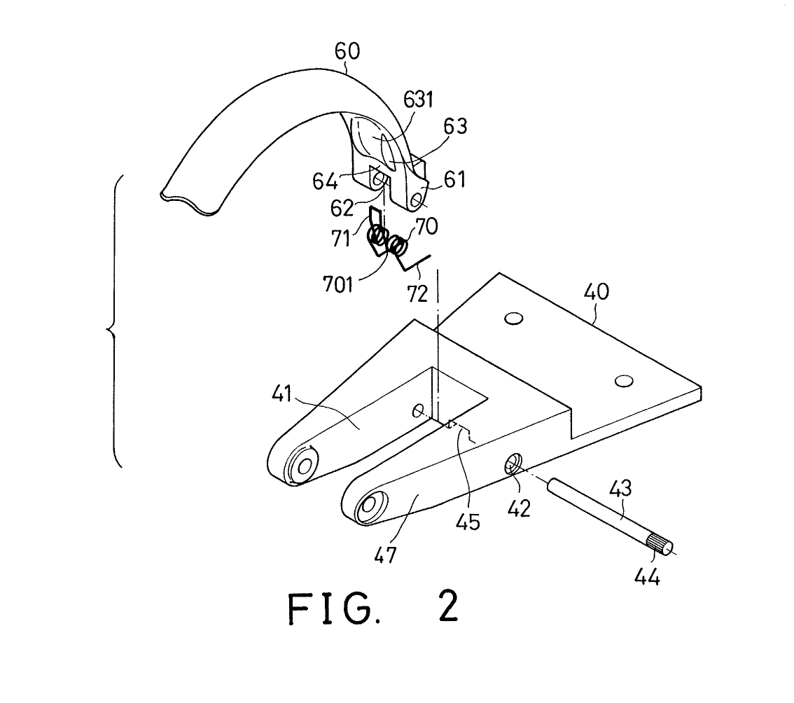

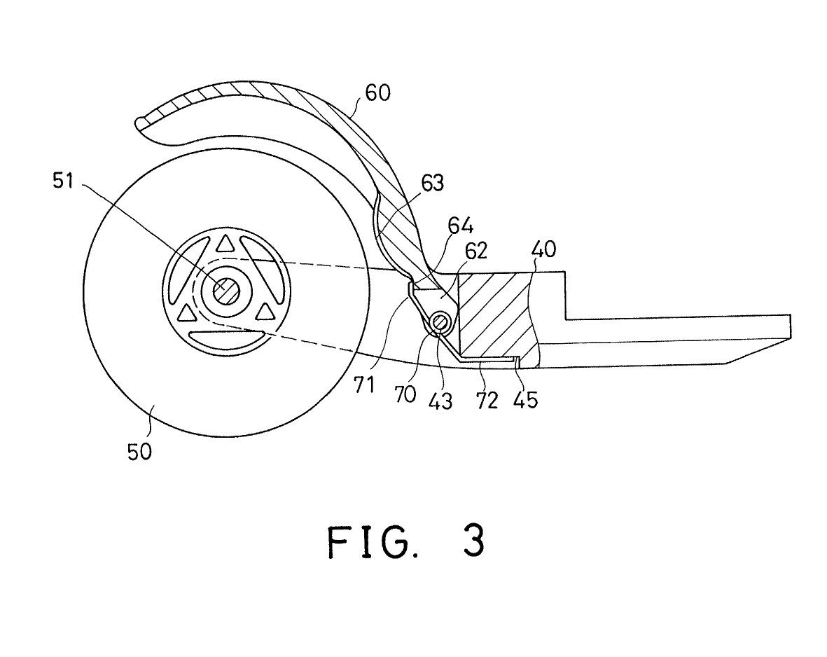

Referring to the drawings, and initially to FIGS. 2 and 3, a scooter in accordance with the present invention comprises a board 40 for supporting a user and including a rear portion having an opening 41 formed therein and defined by a pair of arms 47 and having a depression 45 formed therein and communicating with the opening 41 thereof and having an orifice 42 formed therein and communicating with the opening 41 thereof for receiving a shaft 43. The shaft 43 may be threaded to the board or latched to the board or may include a number of teeth 44 formed thereon for force-fitting onto the board 40 and for solidly securing the shaft 43 onto the board 40. A wheel 32 is rotatably received in the opening 41 that is formed in the rear portion of the board 40 and is rotatably engaged on an axle 51 or is rotatably secured to the board with the axle 51 such that the wheel 32 is rotatable relative to the board 40 about the wheel axle 51.

A mudguard 60 includes one end having a pair of legs 61 extended therefrom and pivotally or rotatably secured to the board 40 with the pivot shaft 43 such that the mudguard 60 may be rotated relative to the board 40 about the pivot shaft 43 and may be moved toward and away from the wheel 50. The mudguard 60 includes an inner peripheral surface 64 facing toward the wheel 50 and includes a bulge 63 extended from the inner peripheral surface 64 thereof and extended toward the wheel 50 for engaging with the wheel 50 and for braking purposes. The bulge 63 includes a curved recess 631 formed therein corresponding to the curved outer peripheral surface of the wheel 50 for snugly engaging with the wheel 50 and for effectively braking the wheel 50. The mudguard 60 includes a notch 62 formed therein and defined between the legs 61 thereof.

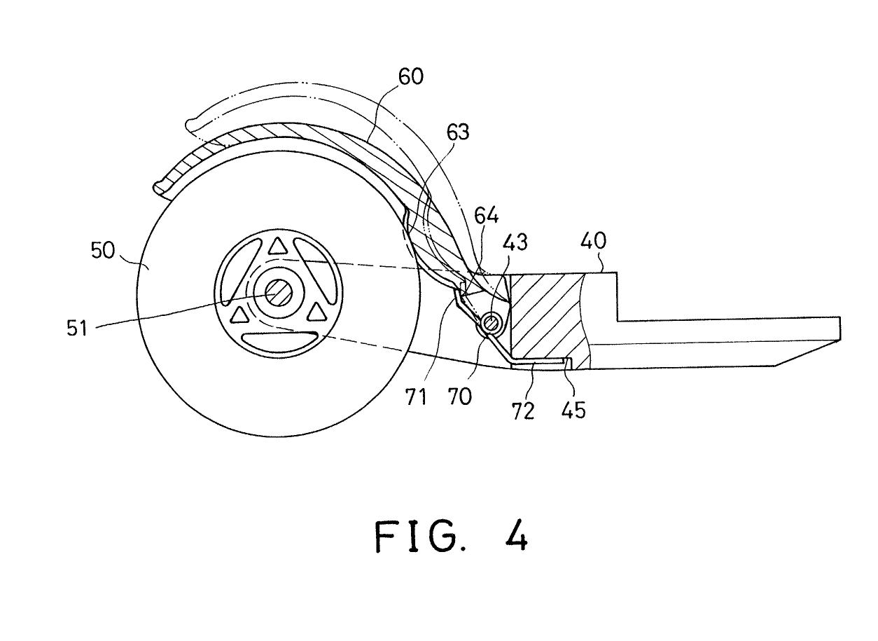

It is to be noted that, as best shown in FIG. 4, the mudguard 60 has only the bulge 63 forced to engage with the wheel 50 and thus has a decreased contacting area with the wheel 50. In addition, the bulge 63 is extended from the mudguard 60 and has an increased thickness in addition to that of the mudguard 60 such that the mudguard 60 may be prevented from being worn out or damaged by the wheel 50.

A torsional spring 70 includes one or more coils 701 received in the notch 62 of the mudguard 60 and engaged on the shaft 43, and includes two outer ends 72 engaged or received in the depression 45 of the board 40 and engaged with the board 40, and includes a U-shaped middle connecting member 71 coupled between the inner ends of the coils 701 for engaging with the mudguard 60 and for biasing the mudguard 60 away from the wheel 50. The mudguard 60 may be depressed downward toward the wheel 50 by the feet of the user, and the bulge 63 of the mudguard 60 may be forced to engage with the wheel 50 in order to brake the wheel 50 of the scooter. The provision of the one or more coils 701 may increase the resilience of the spring 70.

In assembling, the shaft 43 may be easily and quickly engaged through the mudguard 60 and the spring 70 in order to pivotally or rotatably secure the mudguard 60 and the spring 70 to the board 40. In addition, the spring 70 may be solidly engaged on or supported on the shaft 43 and will not be easily disengaged from the shaft 43.

Accordingly, the scooter in accordance with the present invention includes an easily assembled brake device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A scooter comprising:
a board,
a wheel rotatably secured to said board,
a mudguard including a first end,
a spring engaged in said first end of said mudguard, and
a shaft engaged through said first end of said mudguard and said spring for securing said mudguard and said spring to said board,
said spring being engaged with said board and said mudguard for biasing said mudguard away from said wheel.

2. The scooter according to claim 1, wherein said mudguard includes an inner peripheral surface facing toward said wheel, and includes a bulge extended from said inner peripheral surface thereof for engaging with said wheel.

3. The scooter according to claim 1, wherein said first end of said mudguard includes a notch formed and defined between a pair of legs for receiving said spring.

4. The scooter according to claim 1, wherein said spring includes two coils engaged on said shaft, and includes two outer ends engaged with said board, and includes a middle portion connected between said coils and engaged with said mudguard.

5. The scooter according to claim 1, wherein said shaft includes a plurality of teeth formed thereon for engaging with said board and for solidly securing to said board.

6. A scooter comprising:
a board,
a wheel rotatably secured to said board,
a mudguard including a first end rotatably secured to said board with a shaft, said mudguard being movable toward and away from said wheel and including an inner peripheral surface facing toward said wheel, and said mudguard including a bulge extended from said inner peripheral surface thereof for engaging with said wheel, and
means for biasing said mudguard and said bulge of said mudguard away from said wheel,
said bulge being arranged to be forced to engage with and to brake said wheel when said mudguard is forced to rotate relative to said board about said shaft.

7. The scooter according to claim 6, wherein said first end of said mudguard includes a notch formed and defined between a pair of legs, said biasing means includes a spring received in said notch of said mudguard.

8. The scooter according to claim 7, wherein said spring includes two coils engaged on said shaft, and includes two outer ends engaged with said board, and includes a middle portion connected between said coils and engaged with said mudguard.

9. The scooter according to claim 6, wherein said shaft includes a plurality of teeth formed thereon for engaging with said board and for solidly securing to said board.
